(19) United States
(12) Patent Application Publication
(10) Pub. No.: US 2016/0012514 A1
(43) Pub. Date: Jan. 14, 2016

(54) PROVIDING GIFTED TRAVEL-RELATED SERVICES TO A TRAVELER

(71) Applicant: UNITED AIRLINES, INC., Chicago, IL (US)

(72) Inventor: Allison Brown, Libertyville, IL (US)

(21) Appl. No.: 14/328,482

(22) Filed: Jul. 10, 2014

(51) Int. Cl. G06Q 30/06; G06Q 50/14

(52) U.S. Cl. CPC G06Q 30/0635; G06Q 30/0641; G06Q 50/14

(57) ABSTRACT

A method of gifting travel-related services to a traveler includes receiving trip data from a first user, and transmitting the received trip data to a network server for displaying the trip data to a set of secondary users subscribed to access the network server. The method also includes transmitting an access link to the network server to allow each of the set of secondary users to access a gifting interface, and receiving a first request by at least one of the set of secondary users to access the gifting interface via the access link. Still further, the method includes generating a list of the travel-related services or products for display to the at least one of the set of secondary users, and gifting one or more of the travel-related services or products to the first user.

### BACKGROUND OF THE DISCLOSURE

1. Field of the Disclosure

The present disclosure relates to providing travel-related services to a traveler and, more particularly, to a method for providing social gifting of travel-related services to a traveler from another individual or entity.

2. Brief Description of Related Technology

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

In recent years, social networking and social media websites have become more and more integrated into the everyday lives of many individuals. In particular, a traveler often posts pictures, travel updates, and comments on social networking websites during a trip so as to share travel experiences online friends, family, or other acquaintances. For example, a honeymooning couple may (i) upload a message to a social networking site when they depart on a flight, (ii) upload a picture to a social media site when they arrive at a destination, and (iii) periodically upload other content to one or more social networking/media sites while at a destination.

Although individual or entities may interact with a traveler during a trip via social networking, the individual and entities role in the traveler's trip is primarily passive, as to the traveler's itinerary and planning. That is, friends and family of a traveler might view pictures of a traveler's trip, read and comment on messages posted by the traveler, etc., but they are unable to directly enhance a traveler's experiences with activities such as gifting travel-related services or products. A friend might, if given the opportunity, purchase a flight cabin upgrade for a traveler, or a business associate might buy drink service for a traveler. However, such gifting activities are currently either not possible or logistically prohibitive due to the inconvenience and time associated with finding appropriate suppliers of travel-related products and services, retrieving travel details corresponding to the traveler, communicating gifted products and services to a traveler, etc. Thus, friends or other individuals or entities, connected to a traveler through a social network, are not able to seamlessly and easily enhance a traveler's trip while interacting with the traveler on the social network.

### SUMMARY OF THE DISCLOSURE

In accordance with one example, a method of gifting travel-related services to a traveler comprises receiving, at a gift completion device, trip data from a first user, the trip data including information identifying one or more attributes of a scheduled trip of the first user, and transmitting, by one or more processors, the received trip data from the gift completion device to a network server for displaying the trip data of the first user to a set of secondary users subscribed to access the network server. The method also includes transmitting, by the one or more processors, an access link to the network server to allow each of the set of secondary users to access a gifting interface, wherein the gifting interface facilitates the purchase of travel-related services or products corresponding to the trip data, and receiving, from the network server, a first request by at least one of the set of secondary users to access the gifting interface via the access link. Still further, the method includes, in response to receiving the first request, generating, by the one or more processors, a list of the travel-related services or products for display to the at least one of the set of secondary users, and, in response to receiving a second request from the at least one of the set of secondary users to gift one or more of the travel-related services or products, gifting the one or more of the travel-related services or products to the first user and updating the trip data to include the gifted one or more of the at least some of the travel-related services or products.

In accordance with another example, a computing device comprises one or more processors and a non-transitory computer-readable medium. The non-transitory computer-readable medium stores instructions that, when executed by the one or more processors, cause the computing device to receive, at a gift completion device, trip data from a first user, the trip data including information identifying one or more attributes of a scheduled trip of the first user, and transmit the received trip data from the gift completion device to a network server for displaying the trip data of the first user to a set of secondary users subscribed to access the network server. The instructions also cause the computing device to transmit an access link to the network server to allow each of the set of secondary users to access a gifting interface, wherein the gifting interface facilitates the purchase of travel-related services or products corresponding to the trip data, and receive a first request by at least one of the set of secondary users to access the gifting interface via the access link. Still further, the instructions cause the computing device to, in response to receiving the first request, generate a list of the travel-related services or products for display to the at least one of the set of secondary users, and, in response to receiving a second request from the at least one of the set of secondary users to gift one or more of the travel-related services or products, gift the one or more of the travel-related services or products to the first user and updating the trip data to include the gifted one or more of the at least some of the travel-related services or products.

### BRIEF DESCRIPTION OF THE DRAWING FIGURES

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a block diagram of an example social gifting system for providing social gifting of travel-related services to a traveler from another individual or entity;

FIG. 2 is a block diagram of an example mobile device as may be used in the system of FIG. 1;

FIGS. 3, 4A, and 4B are example web pages that allow users to share information about reservations, so as to receive gifted travel-related services or products, that may be implemented by the social gifting system of FIG. 1;

FIGS. 5 and 6 illustrate example social networking content including links to a gifting interface that may be implemented by the social gifting system of FIG. 1;

FIGS. 7 and 8 illustrate example web pages that allow users to gift travel-related services via a gifting completion system such as the system illustrated in FIG. 1;

FIGS. 9A, 9B, and 9C illustrate other example web pages that allow users to gift travel-related services via a gifting completion system such as the system illustrated in FIG. 1;

FIG. 10 is a flow diagram of an example method for sharing and transmitting trip data to facilitate the gifting of travel-related services, which may be implemented in the social gifting system of FIG. 1;

FIG. 11 is a flow diagram of an example method for determining gifts and recommendations presented to a user for the user to use in gifting travel-related services, which may be implemented in the social gifting system of FIG. 1; and

FIG. 12 is a flow diagram of an example method for gifting travel-related services to a traveler, which may be implemented in the social gifting system of FIG. 1; and

FIG. 13 is a block diagram of an example coordinated gifting system.

### DETAILED DESCRIPTION OF PREFERRED EMBODIMENTS

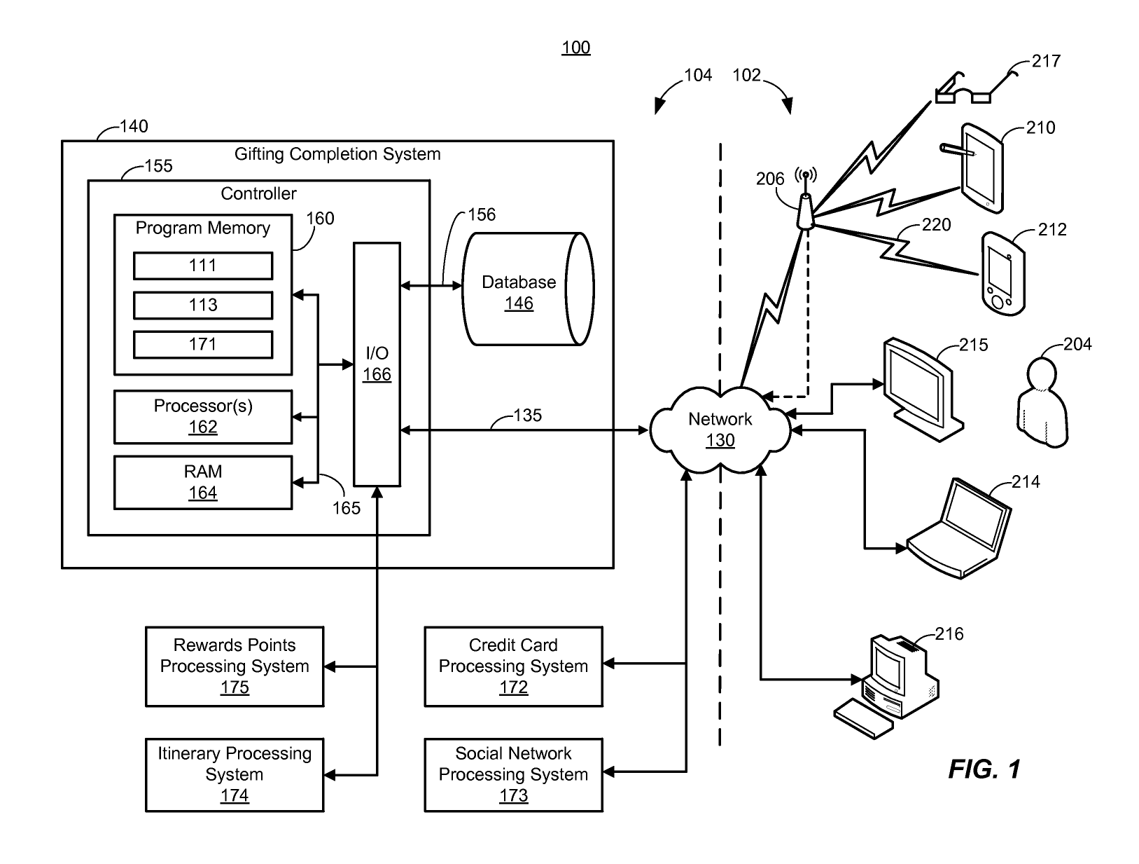

FIG. 1 illustrates various aspects of an example architecture implementing a social gifting system 100. The high-level architecture includes both hardware and software applications, as well as various data communications channels for communicating data between the various hardware and software components. The social gifting system 100 may be roughly divided into front-end components 102 and back-end components 104. The front-end components 102 are primarily disposed within one or more mobile devices 206-217. The devices 206-217 may be located, by way of example rather than limitation, in separate geographic locations from each other, including different areas of the same city, different cities, or even different states. The back-end components 104 may represent a social gifting completion system containing one or more servers or systems communicating with the mobile devices 206-217 through a communication network 130.

For purposes of implementing the social gifting system 100, a customer interacts with the gifting system (e.g., a gifting completion system 140) via a network server, such as a web server communicating via HTTP (hypertext transfer protocol) or any other type of information server capable to transmit information according to any network communications protocol. The network enabled devices may include, by way of example, a network-enabled cellular wireless terminal 206, a tablet computer or personal digital assistant (PDA) 210, a smartphone 212, a laptop computer 214, a desktop computer 216, a wearable wireless communication device such as a wearable computer 217, a kiosk terminal operated by an airline 215, a portable media player (not shown), an e-reader (not shown), or other similar devices (not shown), as used by a user 204. Of course, any network-enabled device appropriately configured may interact with the social gifting system 100. For convenience, throughout the remainder of this description the system 100 will be described with reference to the device 212 (i.e., the smartphone). However, it should be understood that, unless otherwise stated, any reference to the device 212 should be understood as referring to any one of the network-enabled devices 206-217.

The front-end components 102 communicate with the back-end components 104 via a digital network 130. One or more of the front-end components 102 may be excluded from communication with the back-end components 104 by configuration or by limiting access due to security concerns. For example, it may be advantageous for each network enabled device 206-217 to be associated with a user name (e.g., a frequent flyer rewards membership identifier such as the MileagePlus® program offered by United Airlines), and to require a password before allowing the network enabled device 206-217 to access various programs and routines stored in the back-end components 104. The digital network 130 may be a proprietary network, a secure public Internet, a virtual private network or some other type of network, such as dedicated access lines, plain ordinary telephone lines, satellite links, combinations of these, etc. Where the digital network 130 comprises the Internet, data communication may take place over the digital network 130 via an Internet communication protocol. The digital network 130 may communicate with the devices 206-217 through wireless or wired connections. Further, in some examples, the digital network 130 is a mobile (or cellular) communication network.

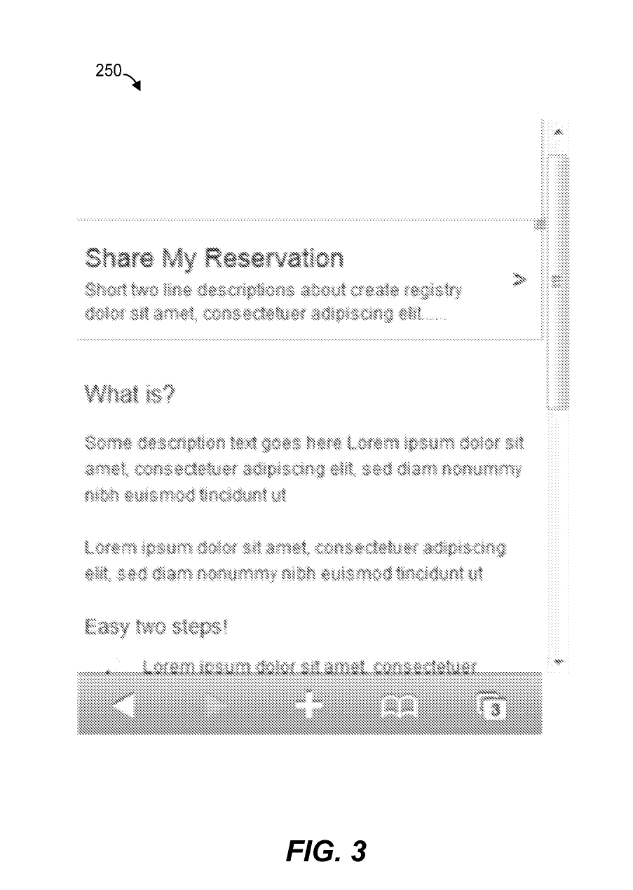

The devices 206-217 need not necessarily communicate with the network 130 via a wired connection. In certain cases, at least some of the devices 206-217 may communicate with the network 130 via wireless signals 220 (e.g., via the network-enabled cellular wireless terminal 206). Generally, the devices 206-217 may communicate with the network 130 via any number of intervening wireless or wired devices (not shown), which may include wireless routers, wireless repeaters, base transceiver stations of a mobile telephony provider, etc., or other access points. Each of the network-enabled devices 206-217 may interact with the intervening wireless or wired devices to receive information including web pages or other information adapted to be displayed on a screen, such as the screens depicted in FIGS. 3-9, for display on the network-enabled devices 206-217. It will be appreciated that although only one server 140 is depicted in FIG. 1, multiple web servers may be provided for the purpose of distributing server load, serving different web pages, implementing different portions of the web interface, etc.

The back-end components 104 include a gifting completion system 140, implemented as a server in this example, as well as a credit card processing system 172, a social network processing system 173, a itinerary processing system 174, and a rewards points processing system 175. Of course, the devices 206-217 may be communicatively connected to different back-end components 104 having one or more functions or capabilities that are similar to the gifting completion system 140 and processing systems 172, 173, 174, and 175. The gifting completion system 140 may include one or more computer processors 162 adapted and configured to execute various software applications and components of the social gifting system 100, in addition to other software applications, such as fraud monitoring or program eligibility. The mobile payment server 140 further includes a database 146. The database 146 is adapted to store data related to the operation of the social gifting system 100, e.g., user profile user data including travel itineraries; name; rewards account number; credit card account numbers; age; address(es); contact information; past purchase histories; behavioral segment; premier status level; analytics; business rules; merchant data; merchant catalog; earn offer content; business rules engine (BRE); etc. The mobile payment server 140 may access data stored in the database 146 when executing various functions and tasks associated with the operation of the social gifting system 100.

Although the social gifting system 100 is shown to include one gifting completion server 140 and the credit card processing system 172, the social network processing system 173, the itinerary processing system 174, and the rewards points processing system 175, in communication with the gifting completion system 140, it should be understood that different numbers of gifting completion servers 140, credit card processing systems 172, social network processing systems 173, itinerary processing systems 174, rewards points processing systems 175, and devices 206-217 may be utilized. For example, the digital network 130 (or other digital networks, not shown) may interconnect, in the system 100, numerous gifting completion systems 140, numerous processing systems 172, 173, 174, and 175, and many thousands of devices 206-217. According to the disclosed example, this configuration may provide several advantages, such as, for example, enabling near real-time uploads and downloads of information as well as periodic uploads and downloads of information. This configuration provides for a primary backup of all the information generated in the social gifting system 100. Alternatively, some of the devices 206-217 may store data locally.

While the back-end components 104 are described as including a gifting completion system 140 in communication with the credit card processing system 172, and the rewards points processing systems 175, each of these systems may represent any type of suitable processing system, as discussed in further examples below.

FIG. 1 also depicts one possible embodiment of the gifting completion system 140. The system 140, as an application server, may have a controller 155 operatively connected to the database 146 via a link 156 connected to an input/output (I/O) circuit 166. It should be noted that, while not shown, additional databases (e.g., containing itineraries, analytics, business rules, gift card data, merchant location data, merchant catalog data, earned offer content data, and fraud data) may be linked to the controller 155 or configured within the database 145. The controller 155 includes a program memory 160, the processor 162 (may be called a microcontroller or a microprocessor), a random-access memory (RAM) 164, and the input/output (I/O) circuit 166, all of which are interconnected via an address/data bus 165. It should be appreciated that although only one microprocessor 162 is shown, the controller 155 may include multiple microprocessors 162. Similarly, the memory of the controller 155 may include multiple RAMs 164 and multiple program memories 160. Although the I/O circuit 166 is shown as a single block, it should be appreciated that the I/O circuit 166 may include a number of different types of I/O circuits. The RAM(s) 164 and the program memories 160 may be implemented as semiconductor memories, magnetically readable memories, and/or optically readable memories, for example. A link 135 may operatively connect the controller 155 to the digital network 130 through the I/O circuit 166.

Various software applications resident in the front-end components 102 and the back-end components 104 implement functions related to completing a social gifting of travel-related services (e.g., the purchase of travel-related products or services by one individual or entity for use by a different traveling individual, or traveler) and provide various user interfaces to allow users (e.g., customers) to access the system 100. One or more of the front-end components 102 and/or the back-end components 104 may include a user-interface application 111 for allowing a user, such as the customer or a customer service representative, to input and view data associated with the system 100, and to interact with the social gifting system 100 described below. In one embodiment, the user interface application 111 is a web browser client, and the application server 140 implements a server application 113 for providing data to the user interface application 111. However, the user interface application 111 may be any type of interface, including a proprietary interface, and may communicate with the application server 140 using any type of protocol including, but not limited to, file transfer protocol (FTP), telnet, hypertext-transfer protocol (HTTP), etc. Moreover, some embodiments may include the user interface application 111 running on one of the network-enabled devices 206-217 (as when a customer is accessing the system). The information sent to devices 206-217 from the application server 140 includes data retrieved from the database 146. The gifting completion system 140 may implement any known protocol compatible with the user-interface application 111 running on the devices 206-217 and adapted to the purpose of receiving and providing the necessary customer information during the gifting process. The gifting completion system 140 includes a transaction resolving application 171 to carry out functions of the gifting completion system discussed below, e.g., functions related to communicating received customer data from the mobile devices 206-217 to the credit card processing system 172, the social network processing system 173, the itinerary processing system 174, and the rewards points processing system 175. The transaction resolving application 171 may be stored in one or more of the program memory 160 or RAM 164.

While not shown in detail, each of the systems 172, 173, 174, and 175 may be similar to those of the gifting completion system 140, and implemented on servers. That is, each of the systems 172, 173, 174, and 175 may include a controller including program memory, a microcontroller or a microprocessor, a random-access memory (RAM), and an input/output (I/O) circuit, all of which are interconnected via an address/data bus (not shown).

The credit card processing system 172 may include an application including algorithms configured to receive transaction data from the mobile devices 206-217, directly or (as illustrated) through the gifting completion system 140. The user (e.g., giver of a travel-related gift) of the mobile device 206-217, or the mobile devices themselves, may be associated with one or more credit card providers; and the system 172 may represents a plurality of different credit card processing systems for each of the user's credit cards. As discussed further below, each credit card processing system may work in conjunction with the gifting completion system 140 to review, authorize and complete a credit card side payment for a transaction, or the giving of travel-related products or services. In some examples, the credit card chosen by a customer (i.e., user) may be associated with a rewards program, for example where use of the credit card accrues corresponding rewards points for that user, or any associated user, in a separate rewards account. In such examples, the credit card processing system 172 may automatically receive or otherwise determine a customer's credit card information based on information associated with the customer's rewards points account.

While in examples the payment processing system 172 is described as a credit card processing system, the system 172 may be any type of suitable payment system that may be integrated for use with a mobile device, as described herein. The system 172, for example, may be a debit card processing system, a wire service (e.g., Western Union®), an automated clearing house system, an online money transfer service (e.g., PayPal®), etc.

The social network processing system 173 may include an application including algorithms configured to receive social networking information (e.g., username, password, content, posts, tags, images, etc.) and interactions with social networking content (clicks, taps, selections, etc.) from the mobile devices 206-217. By way of example, the social network processing system 173 may manage, facilitate communication for, and provide web page content for one or more social networking or social media websites or interfaces, such as Twitter® online messaging service, Facebook®, LinkedIn® professional networking services, Google+™ social service, Pinterest®, Instagram™, YouTube™, Tumblr®, Flickr™, Snapchat®, etc. As used herein, a “social network” refers to a online platform to build social networks or social relations among people who, share interests, activities, backgrounds or real-life connections. The social network processing system 173 may manage and/or be in contact with systems or servers that manage any number of social networking sites, and the social network processing system 173 itself may include multiple servers, databases, networks, etc. that facilitate the operation of one or more social networking or social media website or interfaces. In one scenario, for example, a traveler may post an entry on a social networking site (e.g., via communication between the mobile devices 206-217 and the social network processing system 173) including a text indication that the traveler is traveling and a hyperlink to a travel-related gifting interface (e.g., managed by the gifting completion server). Customers, such as friends, acquaintances, business colleagues, etc. of the traveler, operating other of the mobile devices 206-217 may select (e.g., with a click or tap) posted hyperlinks on websites maintained by the social network processing system 173 to be redirected from a social networking site to gifting interfaces generated by the gift completion system 140. Further examples of social networking/media facilitated gifting are discussed below, and it is understood that, although hyperlinks, posts, redirects, etc. are discussed, the methods described herein are not limited to any particular types of social networking interfaces or interactions.

The itinerary processing system 174 may include an application including algorithms configured to maintain, update, and communicate traveler itineraries and/or other travel-related information related to travelers and/or customers operating the mobile devices 206-217. In some implementations, the itinerary processing system 174 may include a database (not shown) storing current, past, and/or future traveler itineraries (air, bus, train, car, boat, etc. travel itineraries). The itineraries may include, by way of example, travel dates/times, travel service providers, port or gate information, connecting travel information, vehicle information (e.g., aircraft model numbers), directions or instructions, child or dependent information, traveler identification information (name, identification number, etc.), confirmation numbers, flight numbers, frequent traveler rewards information, payment information, traveler contact information, baggage delivery information, and travel options, such as first, second, etc. class designations, priority boarding or access, meal service, media/WiFi service subscriptions, handicap or special needs options, etc. In general, itineraries maintained or accessible to the itinerary processing system 174 may include any suitable information related to travelers and corresponding current, past, and/or future trips on one of more modes of transportation. In an implementation, the itinerary processing system 174 may generate itineraries when a trip is booked, update travel itineraries when reservations are changed or additional products/services are purchased, and provide current travel information to requesting entities such as applications, websites, computing devices, etc. that request travel information and are authorized to view such information.

The rewards points processing system 175 may include an application including algorithms configured to receive transaction data from the gifting completion system 140 and determine an amount of rewards points (e.g., travel miles that may be used for purchase of airfare, hotel, car rentals, and/or others products and services) to award to the user or to a recipient of a travel-related gift for accepting the transaction. The rewards points processing system 175 may include, but is not limited to, a rewards bank, a form of payment system, a data warehouse, a member profile data engine, or some combination of these or some multiple versions of these. In some examples, different rewards points systems may be used for different mobile devices and/or corresponding users and managed through a gifting completion system. It will be appreciated that the reward system may thus be an accrual system used to incentivize transactions between the customer and the merchant. In some examples, the system 175 may determine an amount of rewards points to be generated and awarded to a user upon that user gifting travel-related services to a traveler. In some examples, rewards points are generated and awarded to the traveler, as part of the gifting of travel-related services. In any event, the awarded rewards points may be communicated to a rewards account of a user or an account corresponding to the recipients of a corresponding travel-related gift through the network 130 or through another communication network, such as to a server or processor directly.

Any of the systems 172, 173, 174, or 175 may be implemented separately from the gifting completion system 140 or as integral part of the system 140. For example, the rewards points system 175 may be implemented within the gifting completion system 140, either in the transaction resolving application 171 or elsewhere in the program memory 160, or in a dedicated machine or memory within the system 140 implemented as a server.

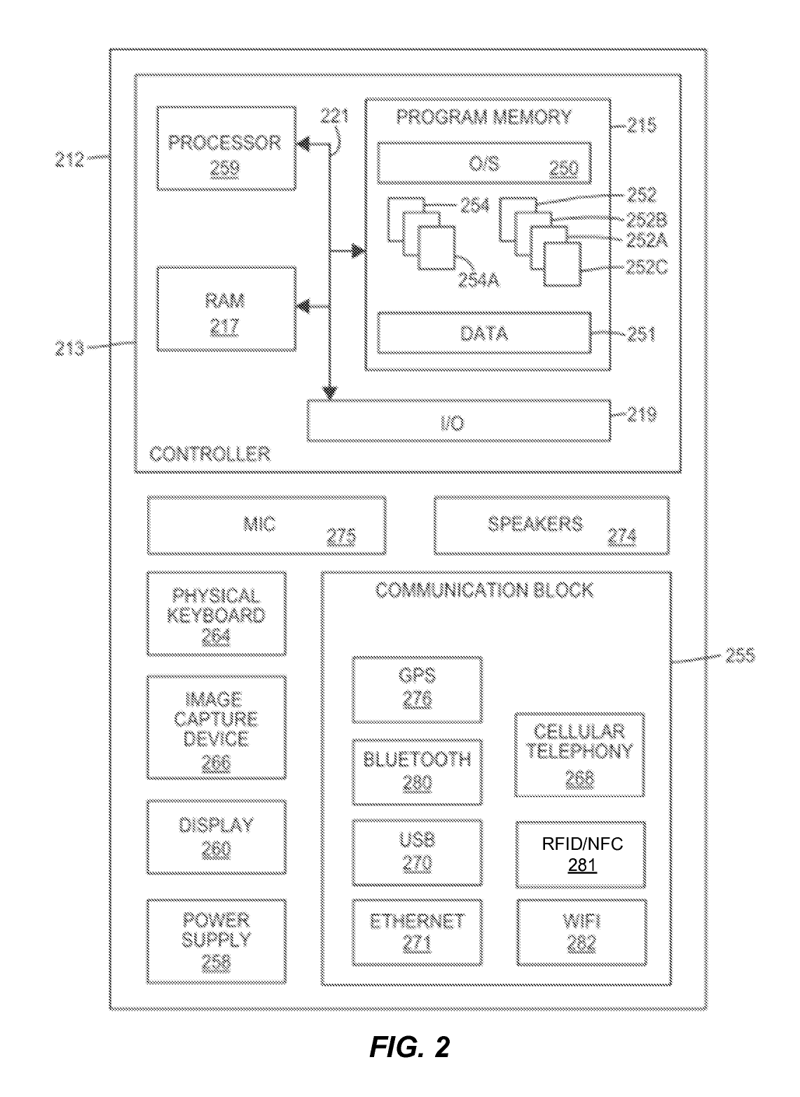

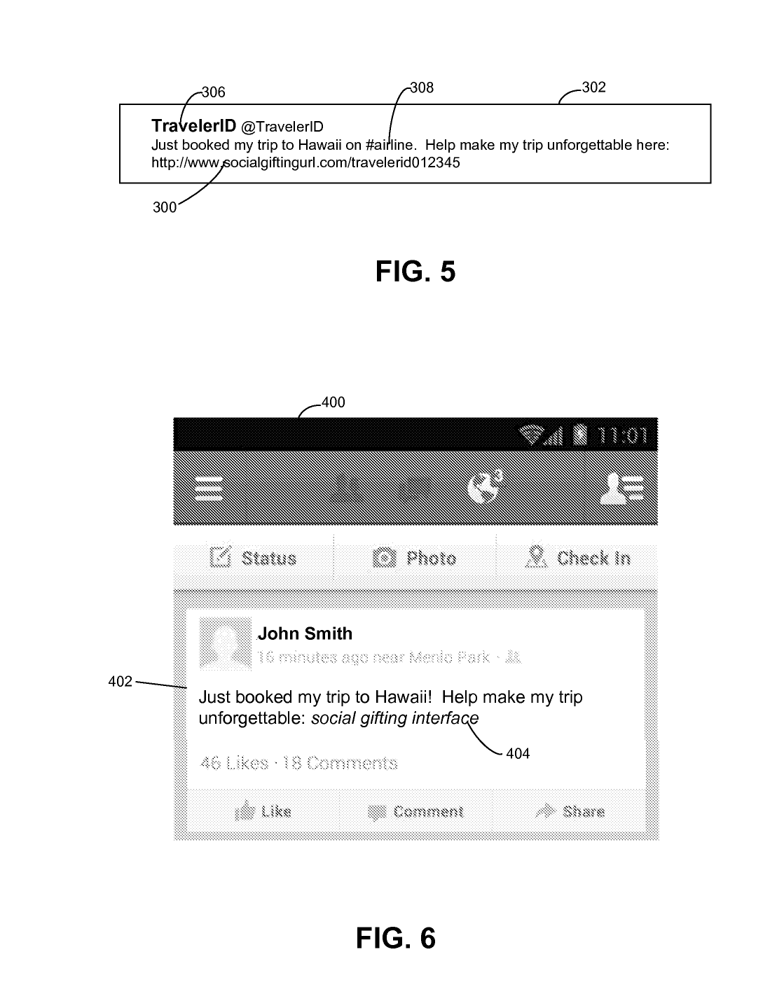

FIG. 2 depicts a block diagram of an example one of the user devices 206-217, for example the smartphone 212. The device 212 may operate in a variety of hardware and/or software configurations. The device 212 includes a controller 213. Similar to the controllers described above, the controller 213 includes a program memory 215, a microcontroller or a microprocessor 259, a random-access memory (RAM) 217, and an input/output (I/O) circuit 219, all of which are interconnected via an address/data bus 221. In some embodiments, the controller 213 may also include, or otherwise be communicatively connected to, a database (not shown) or other data storage mechanism (e.g., one or more hard disk drives, optical storage drives, solid state storage devices, SIM cards, etc.). It should be appreciated that although FIG. 5 depicts only one microprocessor 259, the controller 213 may include multiple microprocessors 259. Similarly, the memory of the controller 213 may include multiple RAMs 217 and multiple program memories 215. Although FIG. 5 depicts the I/O circuit 219 as a single block, the I/O circuit 219 may include a number of different types of I/O circuits. The controller 213 may implement the RAM(s) 217 and the program memories 215 as semiconductor memories, magnetically readable memories, and/or optically readable memories, for example.

The program memory 215 and/or the RAM 217 may store various applications (i.e., machine readable instructions in a non-transitory form) for execution by the microprocessor 259. For example, an operating system 250 may generally control the operation of the device 212 and provide a user interface to the device 212. Various applications 254 may allow the user 204 to perform various functions associated with the device 212. By way of example, and without limitation, the applications 254 may include, among other things: an application for accessing telephony services; an application for sending and/or receiving email; an application for sending and/or receiving text or short message service (SMS) messages; a calendar application; a contact list application; a web browsing application; etc. In particular, the applications 254 may include an application 254A for capturing electronic document data associated with social gifting system 100.

The program memory 215 and/or the RAM 217 may also store a variety of subroutines 252 for accessing specific functions of the device 212. By way of example, and without limitation, the subroutines 252 may include, among other things: a subroutine 252A for accessing geolocation services, a subroutine 252B for accessing image capture services, and other subroutines, for example, implementing software keyboard functionality, interfacing with other hardware in the device 212, etc.

The program memory 215 and/or the RAM 217 may further store data 251 related to the configuration and/or operation of the device 212, and/or related to the operation of one or more of the applications 254 or subroutines 252. For example, the data 251 may be image data captured by an image capture device, may be data input by a user, may be data received from a server (e.g., the application server 140), data determined and/or calculated by the processor 259, etc.

In addition to the controller 213, the device 212 may include other hardware resources. For example, the device 212 may include a power supply 258, which may be a battery in the case of a mobile device. The device 212 may also include various types of input/output hardware such as a visual display 260, a keyboard 264, an image capture device 266, one or more speakers 274, a microphone 275, and/or a pointing device (not shown). In an embodiment, the display 260 is touch-sensitive, and may cooperate with a software keyboard routine as one of the software routines 252 to accept user input.

The device 212 may be configured with a communication block 255 including a variety of hardware for wireless and/or wired communications. Example wireless communication hardware in the communication block 255 may include cellular telephony circuitry 268, GPS receiver circuitry 276, Bluetooth circuitry 280, Radio Frequency Identification (RFID) or Near Field Communication (NFC) circuitry 281, or Wi-Fi circuitry 282 (i.e., circuitry complying with an IEEE 802.11 standard), as well as hardware supporting any number of other wireless communications protocols. Example wired communications hardware in the communication block 255 may include, for example, USB circuitry 270, Ethernet circuitry 271, and/or hardware supporting any number of other wired communications protocols. The RFID/NFC circuitry 281 may be used for numerous different purposes, including, in some examples, to identify items for purchase in a transaction, in place or in addition to other user input means on the device 212.

It should be recognized that different mobile devices may implement different mechanisms for user input. In an example described above, the device 212 may have a touch sensitive display screen 260. Accordingly, “buttons” which are displayed on the screen and are not physical buttons, are “pressed” by touching the screen in the area of the button. However, those of ordinary skill in the art will readily appreciate that such user interface controls may be accomplished in other manners, such as using soft-keys, navigating controls using navigation buttons on a keyboard or using a roller ball, selecting numbers corresponding to different controls, entering information on a keyboard, etc. Additionally, the device 212 may receive voice commands via the microphone 275. Such voice commands may be interpreted by an application 254 (e.g., the Siri® product from Apple Computer).

It should be understood that it may be desirable for some or all of the data transmitted from the system server 140 to the device 212, or vice versa, to be encrypted and/or otherwise transmitted in a secure manner (e.g., using Hypertext Transfer Protocol Secure, known as “HTTPS” or another secure communications protocol).

Typically, a user may launch or instantiate a user interface application (e.g., a web browser, mobile application, or other client application) from a network-enabled device, such as the network-enabled devices 206-217, to establish a connection with the gifting completion system 140 to implement the social gifting system 100. In this way, the gifting completion system 140 may be implemented on a server. In other examples, a gifting completion system may be implemented on a separate computer connected to the digital network 130 through a network server.

The terms “customer”, “consumer”, “gift giver,” and “user” are used herein interchangeably and are not limited to a single person, but may instead represent any person or persons having a reason or desire to gift travel-related services or products to a traveler. Generally, the terms “user”, “customer” and “consumer” are used when referring to a person or persons operating the device 212. The terms “traveler” and “gift recipient” are used herein interchangeably and are not limited to a single person, but may instead represent any person or persons receiving travel-related products or services purchased by a user, or customer. Generally, a traveler may operate a device similar to that of a user or customer.

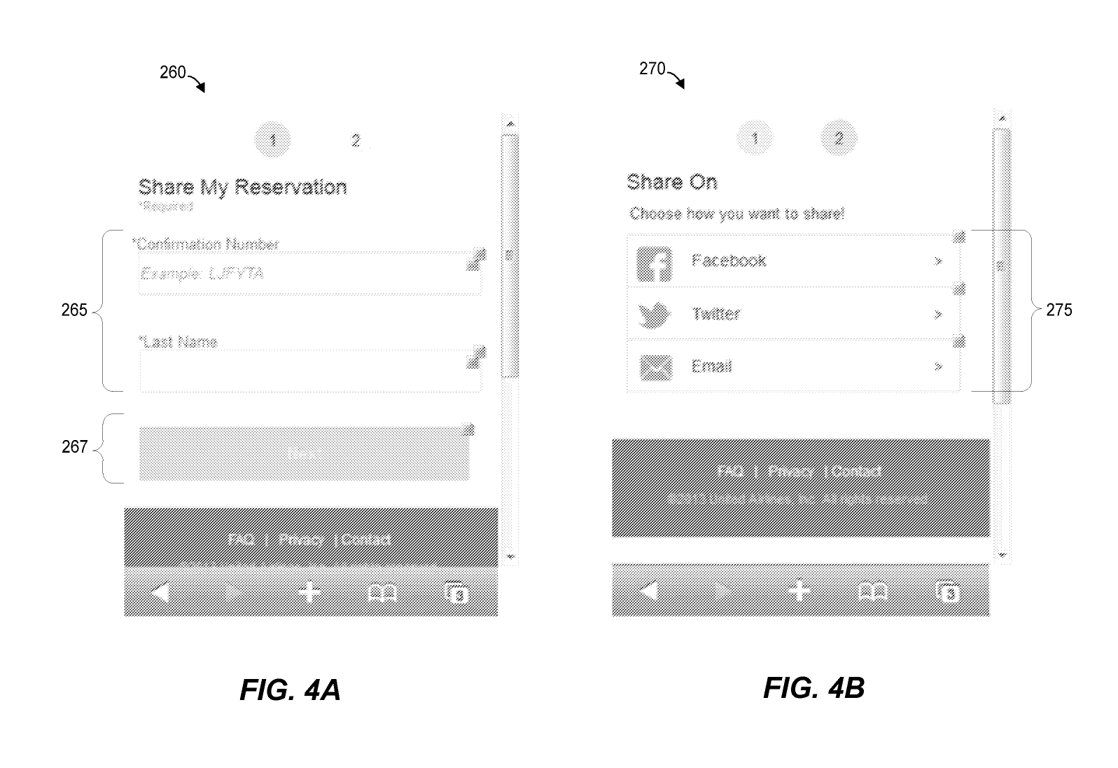

As described above, to access the social gifting system 100, the user 204 (e.g., customer or gifting entity) or a traveler may execute the client application 254A on the device 212. Using the application 254A, the user 204 may request and navigate a series of web pages or screens (see, e.g., FIGS. 4-13) including information transmitted by gifting completion system 140 to the device 212. In some embodiments, the web page or screen may be transmitted as a whole by the server system 140 to the device 212. In other embodiments, some portion of the web page or screen may reside in the program memory 215 of the device 212, while the server system 140 transmits to the device 212 information to populate various fields of the web page or screen.

In some implementations, a traveler may navigate to a first series of web pages allowing the traveler to request, advertise, post, etc. opportunities for other users to gift travel-related services. In turn, the other users may navigate to a second, and potentially different, series of web pages allowing the users to gift travel-related products/services to the traveler. Thus, individual or entities may actively interact with a traveler during a trip via social networking and easily enhance a traveler's trip while interacting with the traveler on a social network. For example, a friend of a traveler may purchase a flight cabin upgrade for the traveler via a link displayed in a social networking post, or a business associate of a traveler might buy drink service for the traveler after viewing a social networking message posted by the traveler. The initiation and processing of such purchases is seamlessly integrated into social networking content corresponding to the traveler, thus promoting socially driven gifting of travel-related services and products.

FIG. 3 is an example web page 250 or application screenshot (e.g., of an applications executing on a client device) allowing a traveler to request, advertise, post, etc. opportunities for other users to gift travel-related services. The web page 250 may be displayed to a traveler in a web browser or other application after the traveler books a reservation (e.g., for an airline ticket) via the web browser application or other application executing on the mobile devices 206-217. The web page 250 may describe the process of sharing travel data (e.g., data related to the booked reservation) via one or more social networking sites/services.

In an implementation, a process of sharing information about a reservation, or travel data, may include an entry of data about the traveler and/or a travel reservation (i.e., travel data) and a selection of an specific social media service through with travel data is shared. FIGS. 4A and 4B illustrate other web pages 260 and 270 or application screenshots in which a traveler may complete these steps so as to share travel data. Specifically, a traveler may enter (e.g., via a keyboard) travel data into one or more fields 265 within the web page 260. For example, a traveler may enter a confirmation number for an airline ticket and their last name such that a system, such as the gifting completion system 140, may verify the identity of the traveler, look up (e.g., query) information about a travel reservation/itinerary corresponding to the traveler, share only travel information associated with a certain reservation/itinerary, etc. To confirm the information entered into the fields 265 and to continue the process of sharing travel information, so as to facilitate the gifting of travel-related services, the traveler may select (e.g., with a tap or a click) a button 267.

The traveler may select a specific social networking site/service on which to share travel data about a reservation via the web page 270. In particular, a traveler may select one of a plurality of listed social networking sites/services 275, in an implementation. At least some of the functionality of one or more of the social networking sites/services 275 may be implemented by the social network processing system 173, as further discussed with reference to FIG. 1. Although, FIG. 4B illustrates three listed social networking sites/services 275, a sharing of travel data (e.g., facilitated at least partially by the gifting completion system 140) may occur via any number of social media sites/services along with other types of communication, such as email, text messages, etc.

FIGS. 5 and 6 illustrate example social networking content (e.g., web pages or posts) uploaded to a social network by a traveler. Also, FIGS. 5 and 6 illustrate example web pages presented to users, or customers, which allow the users to gift travel-related services to a traveler.

In reference to FIG. 5, a traveler may, in a scenario, book a trip with an airline and post a link 300 to a gifting interface in an example social messaging post 302 (e.g., a Twitter® Tweet). The traveler may interact with web pages (not shown) maintained by an airline to book a flight to a destination, such as Hawaii, in the scenario. Subsequently, the airline web pages may give the traveler an option to post, or otherwise embed, the link 300 in social networking/media content such that friends, subscribers, or other individuals or entities (e.g., with access to the traveler's social networking content) may follow the link 300 to gift travel-related products/services to the traveler. The traveler, by way of example, may include a person on their honeymoon, and a customer may include a family member who follows the link 300 to gift a cabin upgrade (e.g., from coach class to first class) to the traveler. In another case, the traveler may be a business guest, and a business associate may follow the link 300 to gift priority boarding access to the traveler.

In some implementations, an airline may provide the traveler with a Universal Resource Locator (URL) link that the traveler may copy into social networking posts or content as the link 300. The traveler may copy (e.g., via a series of taps or a keyboard shortcut) the URL and navigate to social networking web pages, maintained by the social network processing system 173, to generate the social messaging post 302 including the link 300. For example, the traveler may generate and personalize the social messaging post 302 with a keyboard or other user interface on one of the mobile devices 206-217 and include the URL link via a keyboard shortcut corresponding to a paste action.

In an alternate scenario, a travel provider (e.g., airline) may automatically, or otherwise, redirect a traveler from web pages of the travel provider to web pages of a social networking site after the traveler books a trip. For example, an airline may present the user with an option (e.g., a button) to be redirected to a social networking site to post the social messaging post 302. In some cases, the airline may automatically generate the social messaging post 302 and transmit the social messaging post 302 along with the link 300 to the social network processing system 173. The social network processing system 173 may then present the traveler with an interface (not shown) in which the traveler may authenticate an account (e.g., via a username and password) and personalize the social messaging post 302 by changing text, adding tags, etc.

The example social messaging post 302 may include various items other than the link 300. Other items may include a tag 304 indicating a travel provider and a social networking user identification 306 or username. In general, a social networking post, or other content, displaying a link to a gifting interface may include any suitable social networking items or contents, such as timestamps, comments, counts of approval or disapproval, links to other social networking web pages, links to other users of a social network, contact information, geographic location, photos, videos, animated graphics, navigation menus, etc.

FIG. 6 illustrates a social networking web page 400 with another post 402, where the post 402 includes a link 404 to a gifting interface corresponding to a traveler's itinerary. As in the above scenario, the link 300 allows friends, subscribers, or other individuals gift travel-related products/services to the traveler by following the link 404. The post 402 may, for example, be part of content on traveler's Facebook® profile and may be visible to some other Facebook® users, such as friends of the traveler, depending on privacy settings. In some cases, the traveler may configure settings via interactions with the gifting completion system 140 or the social network processing system 173 such that only a subset of the traveler's connections on a social networking site can view the post 402 and follow the link 404.

The link 404 may be represented by a URL as above; but, in general, the link 404 may be represented in any suitable manner such as text, icons, pictures, etc. The link 404 may be selectable (e.g., via a click or tap) and/or the link 404 may change states upon user interaction. For example, the link 404 may change based on a “mouse over” action, such as displaying information about a social gifting interface or changing color for added emphasis.

Further, in some implementations, a social networking post or content generated by the traveler may include specific information about one or more trips corresponding to the traveler. Although not illustrated in FIG. 5 or 6, social networking posts may include dates, times, flight numbers, available options, etc. related to a specific trip. In this way, friends, subscribers, and acquaintances may easily see what type of trip the traveler is taking and what gifting options are available. For example, the post 402 may include, either within the post 402 or upon a mouse over or other action, may display an up-to-date summary of a traveler's itinerary options, such as cabin, purchases services (WiFi, beverage service, etc.), boarding group, etc.

In order to display itinerary information, the gifting completion server 140, the itinerary processing system 174, or other system may communicate part or all of a traveler's itinerary to the social network processing system 173. In some cases, an airline or other provider may only allow portions of a traveler's itinerary to be transmitted or copied to the social network processing system 173. The itinerary processing system 174 may, for example, implement a filter to transmit only available trip options (cabin upgrades, meal service, etc.) corresponding to a traveler's itinerary to a social network and/or the gifting completion system 140. Also, the itinerary processing system 174 may implement certain privacy policies that allow only certain traveler or itinerary information to be transmitted to social networks and/or the gifting completion system 140. For example, the itinerary processing system 174 may implement a rules algorithm based on filtering policies or rules for all travelers (i.e., non-specific rules). Further, in some implementations, the privacy policies or filtering policies may be optionally personalized or modified by a traveler (e.g., by defining rules specific to the traveler via one or more web pages or any other suitable interface). Rules specific to a traveler and default/non-specific rules or policies (e.g., stored in a database) may, in some cases, be implemented as a rules algorithm in the itinerary processing system 174.

Although FIGS. 3, 4A, 4B, 5, and 6 emphasize a process in which a traveler can share travel data via a series of interactions with a web interface, the gifting completion system 140 may, in some implementations, automatically trigger the sharing of travel data, assuming the traveler consents to such use of the travel data (e.g., “opts in”). For example, a profile (e.g., stored in the database 146) corresponding to a traveler may indicate that the travelers has consented to the sharing of travel information upon booking a flight, or other travel-related service. In such as case, the gifting completion system may automatically generate one or more social media/networking posts or messages similar to those illustrated in FIGS. 5 and 6 and communicate the posts or messages to the social network processing system 173 for presentation.

Further, in some implementations, the gifting completion system 140 may further incentivize social gifting by triggering the re-posting or re-messaging of automatically or manually generated social media/networking messages including travel data. For example, the gifting completion system 140 may interact with the social network processing system 173 to re-post a social networking message, such as the message illustrated in FIG. 6, periodically during a time period leading up to a the traveler leaving for a trip (e.g., up until the time of a flight or within a time threshold of a flight). Alternatively, the gifting completion system 140 may trigger the re-posting of social media messages (including travel data) at increasingly frequent times leading up to a trip. In some implementations, a traveler may simply consent to such automatic re-posting or sharing of travel data with options for gifting, or the traveler may pay more/less (e.g., when booking a flight), depending on business consideration, for the automatic re-posting of messages.

Still further, the gifting completion system 140 may automatically notify, via social networking messages, emails, text messages, or any other suitable notifications, a customer regarding a gifting opportunity for a traveler. For example, based on previous gifting by a customer, data about the customer retrieved from the social network processing system, or information supplied by the customer, the gifting completion system 140 may automatically determine that the customer should be made aware of certain gifting opportunities. For example, when a friend or family member of a customer books a trip with an airline (that operates the gifting completion system 140), the gifting completion system 140 may automatically notify the customer (e.g., via email) about the friend or family member's trip along with a link to gift travel-related products or services. That is, the gifting completion system 140, in addition to allowing traveler's to share travel data for potential gifting, may automatically share travel data with friends, family members, coworkers, previous gifters, previous gift recipients, etc. to promote the giving of travel-related gifts to the traveler from the friends, family members, coworkers, previous gifters, etc. Generally, such targeting and incentivizing of customers (gifters) occurs from a determined connection between the customer and the traveler. Such connections between a customer and a traveler may be determined by the gifting completion system 140 using social connection rules of that system 140. In other examples, such connections may be determined using rules from the social network processing system 173, or some combination thereof.

In one scenario, a traveler may book a flight. The gifting completion system 140 may then automatically determine that the traveler has been gifted travel-related services (e.g., flight cabin upgrades) by certain individuals in the past (e.g., based on data stored in the database 146). The gifting completion system 140 may then automatically notify these certain individuals about the booked flight of the traveler. For example, the gifting completion system 140 may automatically post social media messages in which the certain individuals are “tagged,” or the gifting completion system 140 may automatically send the certain individuals emails, text messages, PUSH notification, etc. including travel data about the traveler's trip. In this manner, the gifting completion system 140 may promote the gifting of travel-related services for the traveler from previous customers. In some implementations, the traveler may “opt-in” or “opt-out” of such automatic notifications when booking the flight or when configuring a user profile with the operator of the gifting completion system 140 (e.g., an airline).

In other scenarios, a traveler may book a flight; and the gifting completion system 140 may then automatically determine that the traveler, herself, has gifted travel-related services (e.g., flight cabin upgrades) to certain individuals in the past (e.g., based on data stored in the database 146). The gifting completion system 140 may automatically notify these certain individuals about the booked flight of the traveler, in a similar manner to the notifications above. In this type of incentivizing, the gifting completion system 140 seeks to incentivize reciprocal gifting, by looking to past gift recipients and suggesting to them that they now gift travel related services or products to people that had previous gifted travel related services or products to them.

Other connections and statistics about customers and travelers may be used for incentivizing gifting of travel related products and services. For example, usage data from the one or more mobile devices 206-217 may be used to identify potential customers or gifters. Those individuals who more frequently use a travel gifting mobile application or social networking application may be automatically targeted, with the travelers consent, for gifting. The data shared between mobile applications running on one of the mobile devices 206-217 may be managed by the social network processing system 173, e.g., Facebook® online social networking service. The gifting completion system 140, therefore, may identify potential customers for gifting of travel related products and services based on shared data received from other mobile applications running on one of the mobile devices 206-217. For example, the gifting processing system 140 may receive (or collect) data from mobile applications running on a customer's smartphone 212 identifying recently consumer products that the customer has purchased, searched for, ‘liked’, etc. using their smartphone 212. The gifting processing system 140 may also receive (or collect) data from these mobile applications indicating user interest in travel, such as accessing travel websites, etc. The gifting processing system 140 may then identify, from such data, users that are more likely to gift travel related services to a traveler than other users, where such determinations are used for automatically incentivizing these users by notifying them of opportunities to gift services to upcoming travelers.

In any of these examples, the gifting processing system 140 may also categorize and prioritize customers based on the determined likelihood they will gift travel related products or services. Categorizing and prioritizing customers may allow the gifting processing system 140 to increase or decrease the frequency of notifications, alter the type of notification, or use a particular mode of notification to a customer for a traveler's upcoming trip.

In some examples, a traveler or customer may “opt-out” of some or all automated features of the gifting completion system 140. For example, certain travelers or customers may prefer to not have any travel data or information about gifted travel-related services or products automatically communicated to customers or posted to social networking/media sites. Instead, the certain travelers or customers may prefer to manually (via copy/paste actions, emails, etc.) travel data, or they may prefer to not communicate or post any travel data. In such cases, these certain travelers or customers may “opt-out” of automated features of the gifting completion system 140 such that, upon booking flights, reserving hotels, or making other travel arrangements, the gifting completion system 140 does not automatically “sync” travel data with social media/networking systems or communicate travel data (including gifting options) in any other manner (e.g., email). The gifting completion system 140 may allow travelers and customers to indicate this preference when making travel-related purchases or when making travel arrangements (e.g., via one or more web pages generated by the gifting completions system 140), in an implementation.

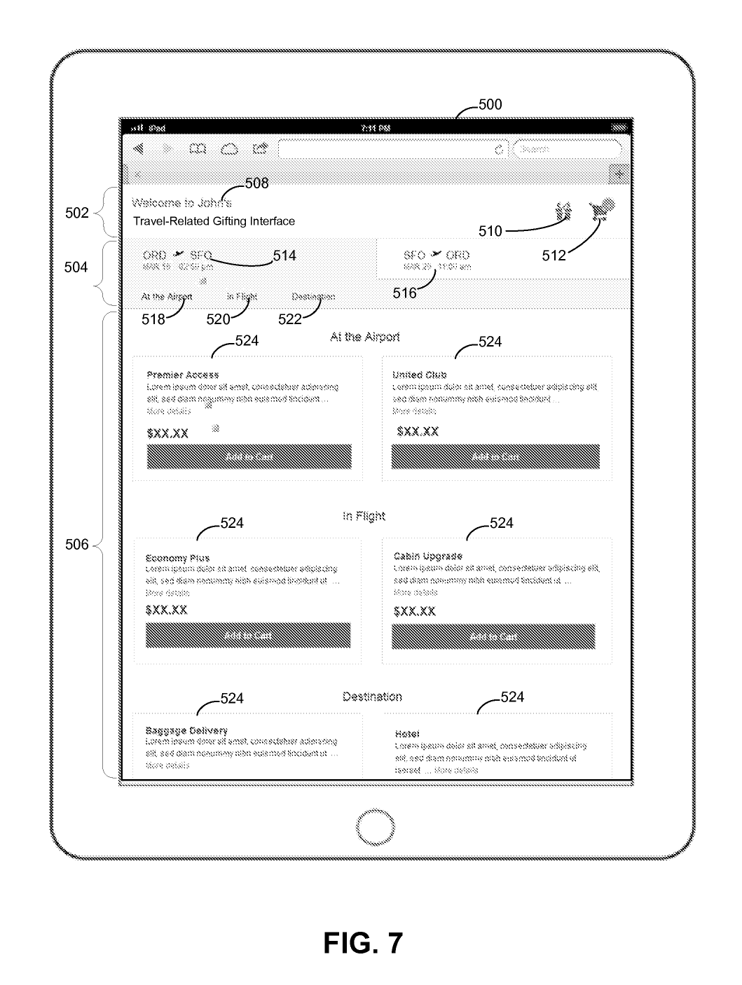

Now referring to FIG. 7, a customer, such as a friend or other acquaintance, may follow a link (e.g., by clicking one of the links 300 or 404) to an example gifting interface 500 maintained by a gifting completion system. The customer may then gift travel-related services and products to one or more travelers via the gifting interface 500. The gifting interface 500 may be displayed in a web browser application or dedicated application “installed” on one of the mobile devices 206-217 and may include content from the gifting completion system 140 or other suitable system or server, for example.

In an implementation, the gifting interface 500 may include title, traveler, and other general information 502, itinerary information 504, and a variety of gifting options information 506. Although FIG. 7 illustrates a certain format and arrangement of the general information 502, the itinerary information 504, and the variety of gifting options 506 within the gifting interface 500, it is understood that information or content of a gifting interface may be arranged and/or represented within a gifting interface with any suitable combination or formats and arrangements.

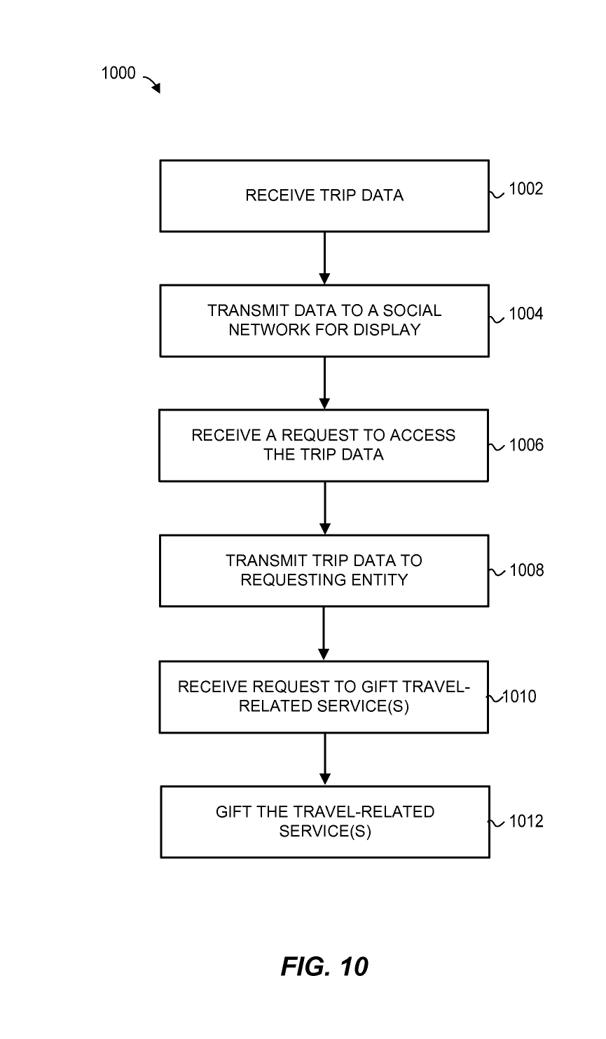

The general information 502 of the gifting interface may include information identifying a traveler 508, a selectable icon 510 for a user to display current/available/purchased gifts, and a selectable “shopping cart” icon 512 for a user to view currently selected gifts for purchase. In some cases, a customer may follow a link, via selection of the icon 512, to view currently selected gifts, provide payment information (credit card numbers, billing address, etc.), and complete a gifting transaction. Such information provided by the customer, may in an implementation, be communicated to the gifting completion system 140, credit card processing system 172, or other suitable server or system to complete a gifting transaction. The transaction resolving application 171, for example, may utilize payment information provided by a customer to complete a gifting transaction, as further discussed with reference to FIG. 10.

The itinerary information 504 may include indications of departing flight information 514 and indications of return flight information 516, in the example gifting interface 500. However, it is understood that any filtered or selected information from a traveler's itinerary may be displayed in the gifting interface 500, including any number of legs or portions of a trip. In this way, the gifting interface allows a customer to easily view where, when, and how the traveler is traveling to a destination and returning home. Further, in some implementations, a customer may select (e.g., via a click or tap) the indications of departing flight information 514 or the indications of return flight information 516 to view gifting options, in the gifting options information 506, specifically relevant to a traveler's departing travel or to a traveler's return travel.

In general, the gifting interface 500 may include any number of selectable itinerary related buttons, tabs, and other items allows a customer to view gifting options specifically relevant to a particular portion of a travel itinerary. For example, in addition to departing and/or return options, the customer may select an “at the airport” icon 518, an “in flight” icon 520, and a “destination” icon 522. Customer selection of each of the icons 518, 520, and 522 may trigger the display of gifting options specifically relevant to when a traveler is at an airport, in flight, or at a destination, respectively, in the gifting options information 506. For example, gifting options relevant at the airport may include WiFi access, access to an airline club, restaurant coupons, etc. Further examples of gifting options are discussed below.

Although the gifting interface 500 illustrates the gifting options information 506 as being changeable based on customer selection of different travel stages (e.g., at an airport), it is clear that a gifting interface may present the customer with any number of gifting options according to any suitable rules. For example, a customer may establish a customer profile for the gifting interface 500 during a registration process, and gifting options may be presented to the customer in the gifting options information 506 according to user preferences. A customer may, in one case, prefer to gift in flight services or products, while another customer may prefer to gift services or products below or above a certain price.

The gifting options information 506 may include a plurality of indications 524 each corresponding to a specific gifting option. Each of the example plurality of indications 524 includes a summary of the corresponding gifting option, a price of the gifting option (e.g., in dollars and cents or other currency), a link to further information about the gifting option, a selectable icon to add the gifting option to a shopping cart, etc. In some cases, a user may scroll through (e.g., via a scroll bar or drag gesture) the plurality of indications 524 to view all available gifting options or all available gifting options corresponding to a specific stage of travel. In general, the plurality of indication 524 may be presented to a customer via any suitable format, such as a list, table, plurality of thumbnail images, scrolling text, slideshow, drop-down menu, etc.

By way of example and without limitation, gifting options specifically relevant to an “in flight” stage of departing or return air travel include cabin upgrades (first, coach, economy plus, business class, etc.), meal service or upgraded meal service, beverage service or beverage coupons, and in flight WiFi or other media (TV, movies, etc.) services. Example gifting options specifically relevant to an “in an airport” stage of travel may include access to an airline or other club, priority or premier boarding access to a flight, baggage upgrades or discounts, and WiFi or other media services, and gifting options specifically relevant to an “at destination” stage of travel may include car rental, car service (limo, taxi, etc.), hotel reservations, hotel upgrades (larger room, spa access, etc.), gift cards to shopping destinations, gift cards for activities, and other gift cards or coupons for products and/or services at a destination.

In addition to itinerary dependent products and services, such as hotel reservations or in-flight meal service, gifting options may include itinerary-independent options, in an implementation. For example, a customer may gift a subscription to a traveler, such as a subscription to a rewards program, a checked baggage program, an award accelerator program, a premier traveler program, etc. Alternatively, a customer may, in some cases, purchase miles, discounts, or other products or services that may be used by the gift recipient (i.e., traveler) at any time or place independent of a specific trip itinerary.

Some or all of the products and services available for gifting may be associated with entities other than a travel provider corresponding to a traveler, such as an airline, bus, or train company. For example, an airline may establish business relations with a variety of travel-related product and/or service providers and provide enhanced visibility and discovery of corresponding partner products/services via the gifting interface 500. Such travel-related partners may include retail stores, car services, car rental services, taxi companies, bus companies, hotels, casinos, restaurants, media/internet providers, wireless providers, credit card companies, etc.

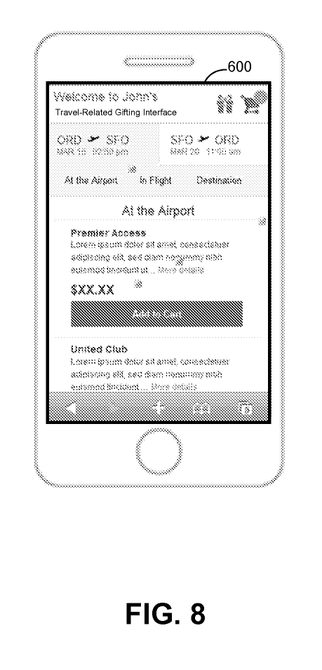

Although the gifting interface 500 is illustrated in FIG. 7 in a certain format which may be visually appealing or functional on certain of the mobile devices 206-217, a gifting completion system, such as the gifting completion system 140 or other suitable system, may provide different versions of the gifting interface 500 to a variety of different mobile device types. For example, the gifting interface 500 may be visually appealing or functional (e.g., as determined through usability studies) on a tablet computer, whereas another gifting interface 600 (illustrated in FIG. 8) may be visually appealing or functional on a smartphone device. In some implementations, the gifting completion system 140 may selectively send a specific version of a gifting interface to one of the mobile devices 206-217 based on device identification information included in messaging or communication protocols. For example, the gifting completion system 140 may selectively send the gifting interface 600 to a smartphone based on device information included in an HTTP message or request.

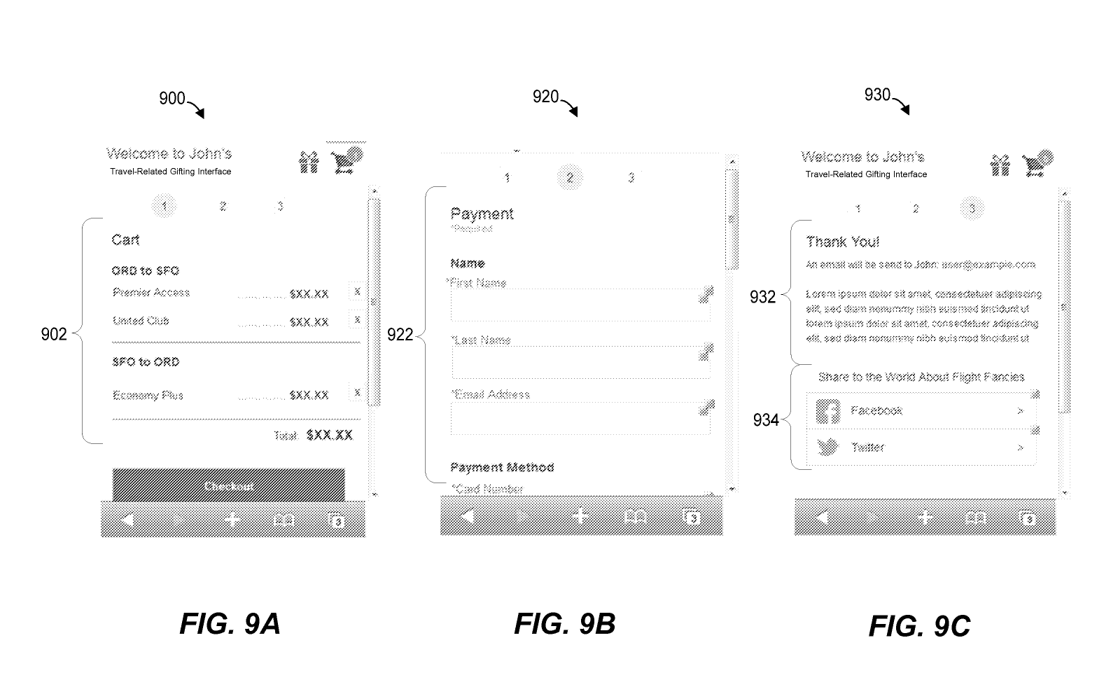

FIGS. 9A, 9B, and 9C illustrate an example process, via one or more web pages 900, 920, and 930, that a customer may complete to pay for and share information about gifted travel-related services. In particular, the web page 900 may include a summary 902 of an order for travel-related services, and a customer may pay by entering payment information in one or more fields 922 of the web page 920 (e.g., credit card numbers, billing addresses, etc.). After completing the order for travel-related services, a customer may view the web page 930 with further information 932 about the order and options 934 for sharing information about gifting the travel related services/products to the traveler.

In an implementation, customers may share (e.g., via the options 934) information via the same or different social networking/media sites/services as the sites/services used by the traveler to share travel data. For example, customers may share information such as notifications of the gifting of travel-related items, information about which services/products were gifted, links to travel providers providing the gifted services/products, personalized messages, etc. Further, in some implementations, the information shared by customers following the gifting of travel-related services/products may include at least some of the travel data originally shared by a traveler, assuming the traveler consents to such use of the travel data. In this way, customers may both notify their friends, followers, etc. of their gifting and make the original shared information by the traveler more visible within a social network.

FIG. 10 is a flow diagram of an example method 1000 of providing travel-related services to a traveler. The method 1000 may be implemented in the gifting completion system 140, for example; but, in general, the functionality described in the method 1000 may be implemented by any suitable computing devices, such as any of the front-end components 102 and/or the back-end components 104. Elements of FIGS. 1 and 2 will be referred to below for ease of discussion, however, it is understood that any suitable computing device(s) with any number of processors, memory, and storage media may implement the method 1000.

First, trip data is received by the gifting completion system 140 from a traveler operating one of the mobile devices 206-217 (block 1002). The one of the mobile devices 206-217 may be executing the application 254A, for example, to allow the traveler to arrange, purchase, and share a travel itinerary. In some cases, the traveler may make travel arrangements (e.g., book airline tickets) via communication with a server or system other than the gifting completion system 140, and then the traveler may send arranged travel data to the gifting completion system 140. For example, a traveler may purchase and generate an itinerary via the itinerary processing system 174, and, subsequently, the itinerary processing system 174 may communicate travel data to the gifting completion system 140. Alternatively, a traveler may purchase travel arrangements via direct communication with the gifting completion system 140.

Travel data received from a traveler may include, by way of example, flight times/dates, flight numbers, contact information, travelers names, travel options or any other information/attributes included in a travel itinerary. Additionally, travel data may include requests from the traveler to share travel data and gifting options via one or more social networks. For example, a traveler may request (e.g., via a web interface selection) that travel data corresponding to a particular travel itinerary be shared via the traveler's Facebook® account. In some cases, the traveler may provide specific details of a social networking account, such as usernames, passwords, etc., and, in other implementations, the traveler may simply provide a request to share travel data and gifting options.

Next, the gifting completion system 140 transmits data, such as some or all of the received trip data, to a network server, such as the social network processing system 173 (block 1004). In a simplistic implementation, the gifting completion system 140 may redirect a traveler from web pages at which the traveler purchased an itinerary to web pages of a social network, and the gifting completion system 140 may provide the traveler (e.g., via a web page or email) with an access link (e.g., URL) to a gifting interface. In turn, the traveler may post or share travel data including the link to the gifting interface (e.g., corresponding to a specific itinerary described by the travel data), as further described with respect to FIGS. 5 and 6. In another implementation, the gifting completion system 140 may provide all or part of a travel itinerary directly to the social network processing system 173 along with an authentication (e.g., username and password) provided to the gift completion system 140 from the traveler. In turn, the social network processing system 173 may automatically, or otherwise, generate a message, post, or other content including at least some of the travel data or itinerary information.

In some implementations, the gifting completion system 140 may provide a social network server and/or traveler with suggested or example content to post to a traveler's social networking pages. For example, the gifting completion system 140 may use a variety of templates (e.g., stored in the database 146) to generate an example social networking message post including trip data and a link to a gifting interface at which customers may gift products/services to the traveler. The templates may include example text (e.g., “Just booked my trip to . . . ”), variables (e.g., $AIRLINE or $DESTINATION) which may be filled with portions of travel data, pictures, video, slogans, etc. In some cases, the example content may be provided directly to a social network, such as the social network processing system 173 for posting on web pages corresponding to the traveler, and, in other cases, the traveler may receive, view, and/or modify the example content via communications with the gifting completion system 140 or the social network processing system 173.

In reference again to FIG. 10, after transmitting data to a network server, the gifting completion system 140 may receive a request by one or more individuals or entities other than the traveler (e.g., customers such as friends or acquaintances of the traveler) to access a gifting interface or webpage (block 1006), where the gifting interface allows the individuals to view further trip data and gifting options. In response to the request, the gift completion system 140 may transmit gift interface content (or trip data) to one or more devices operated by the one or more requesting individuals (block 1008), such as the content illustrated in FIGS. 5 and 6 including travel, or trip, data indicative of travel-related services that are giftable to the traveler. For example, when a link, such as the link 300 or 404, is accessed by friends on a traveler (e.g., on a social networking website), embedded HyperText Markup Language (HTML) code (e.g., executed on one of the mobile devices 206-217) may request that the gift completion system 140 transmit travel data to the mobile devices 206-217.

A request to gift particular travel-related services or products is then received by the gifting completion system 140 (block 1010). In one scenario, a friend or acquaintance of the traveler may follow a link, such as the link 300 or 404, select one or more travel-related services or products, such as one or more of the plurality of indications 524, and follow a shopping cart link, such as the icon 512, to pay for the services or products and communicate a request to gift the selected services or products to the gifting completion system 140. However, it is clear that a customer may follow any suitable process in a gifting interface to communicate a request to gift to the gifting completion system 140. One example payment and sharing process for gifting travel-related services is illustrated with reference to FIGS. 9A, 9B, and 9C.

The gifting completion system 140 may then gift the particular travel-related services or products to the traveler based on the request (block 1012). By way of example and without limitation, gifting travel-related services or products to a traveler may include one or more of: (i) updating an itinerary or other stored data corresponding to a traveler in a database operated by a travel provider (e.g., an airline); (ii) communicating an indication of the gift to the traveler; (iii) communicating a confirmation of the gift and payment thereof to the one or more individuals or entities, or the “customer,” that requested the gifting of the products or services; and (iv) communicating with and/or transmitting data to third party systems or servers, such as those corresponding to certain gift cards, business partners, financial institutions, charitable organizations, enterprise systems, or credit card companies.

In one implementation, gifting may include the gifting completion system 140 updating, or causing the itinerary processing system 174 to update, a traveler's itinerary and or travel data in one or more databases. A customer may, for example, request to gift a cabin upgrade to the traveler including an upgrade from coach class to first class on a specific flight. As a result, the gifting completion system 140 may communicate the upgrade to the itinerary processing system 174, and the itinerary processing system 174 may update a database entry corresponding to the traveler's cabin class on the specific flight. In another scenario, a customer may request to gift a subscription to gift an airline club (e.g., member only airport lounge corresponding to the airline) subscription to the traveler. As a result, the gifting completion system 140 may update a database entry corresponding to the traveler (e.g., identified by name or personal identification number) in a database, such as the database 146.

Also, the gifting completion system 140 may communicate an indication of the gift to the traveler and/or communicate a confirmation of the gift to the customer (i.e., gift giver). The communication may include confirmation number, receipt documents, summaries of gifts, updated boarding passes, gift card codes, updated itineraries, etc. Such a communication may occur based on any suitable formats, protocols, communicative connections, etc. For example, the gifting completion system 140 may send an automated email to the traveler/customer, or the gifting completion system 140 may send a mobile alert to one or more of the mobile devices 206-217 via an installed application. In other cases, the gifting completion system 140 may send the communication via a phone call or text message.

The communication to the traveler may occur immediately after the gifting of the travel-related products or services, or the communication may occur at some pre-determined or otherwise determine time after the gifting. That is, gifting communications from the gifting completion system 140 may be delayed. In one implementation, the traveler may be notified of the gifting when arriving at an airport, checking in to a flight, or arriving at a gate or port in which an airplane, boat, train, etc. is docked, and, in some cases, a customer may optionally choose to inform the traveler at a certain point in time. In this manner, customers may gift travel-related services and products before a trip occurs, and a traveler may be informed well before, immediately before, or during the trip. Informing the traveler of gifted products or services immediately before or during a trip may allow customers to surprise the traveler with the products or services, for example.

Gifting may further include communicating with and/or transmitting data to third party systems or servers, such as those corresponding to certain gift cards, business partners, financial institutions, enterprise systems, or credit card companies. In one scenario, for example, a customer may request to gift a gift card to the traveler, where the gift card is used for purchasing products or services with a business partner (retail store, hotel, restaurant, etc.). As such, the gifting completion system 140 may communicate traveler, customer, travel, itinerary, and/or payment information to a third party gift card processing system such that the gift card is authorized for use and associated with the traveler. The gifting completion system 140 may communicate with the credit card processing system 172 to facilitate the completion of a charge to a credit account corresponding to the customer. In general, gifting by the gifting completion system 140 (e.g., by execution of the transaction resolving application 171) may involve communications and/or data transfer to any number of third party server or systems. Moreover, the gifting completion system 140 may communicate with one or more enterprise systems, such as calendars, contact management systems, proprietary databases, customer relationship management systems, accounting systems, etc., such that gifting of travel-related services is integrated into the enterprise systems. In addition to following links on social networking posts, individuals may follow links or other indications of gifting opportunities within an enterprise system to gift travel-related products or services. For example, a business associate may follow a link included in a calendar entry corresponding to a traveler to gift travel-related services or products to the traveler. In some implementations, enterprise systems with gifting integration may automate gifting for employees or business associates.

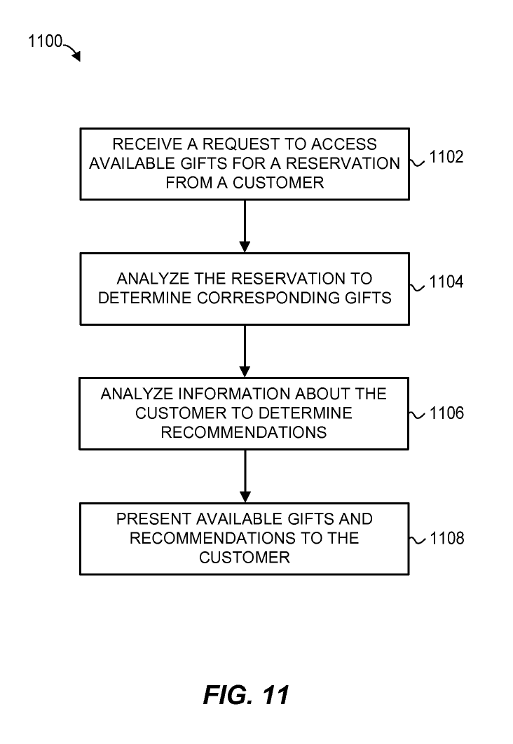

FIG. 11 is a flow diagram of an example method 1100 for determining for determining gifts and recommendations presented to a customer while the customer is gifting travel-related services. The gifting completion system 140 may implement the method 100, for example.

First, a request to access available gifts corresponding to a certain reservation/itinerary is received (block 1102). For example, a customer may click on a unique hyperlink in a social media post (e.g., uploaded by a traveler as discussed with reference to FIGS. 3, 4A, 4B, 5, and 6) to navigate to one or more web pages or application content allowing the customer to gift travel-related services/products to a traveler. Upon clicking the link, the gifting completion system 140 may receive a request for the one or more web pages or application content, the web pages indicating specific gifts available for purchase.

The gifting completion system 140 may analyze a reservation, itinerary, and other travel-related information to determine the specific gifts for the traveler that are available for purchase (block 1104). In particular, the gifting completion system 140 may utilize the itinerary processing system 174 to analyze a travel-related reservation corresponding to the traveler (for which the customer wishes to purchase a gift). In some cases, only certain quantities of certain gifts may be available for purchase, such as one upgrade to first class, three drink vouchers, one pass for an airport lounge, two vouchers for in-flight movies, etc. As such, the gifting completion system 140 may determine, based on a current itinerary corresponding to the traveler, which and how many of these certain gifts are available for purchase.

The gifting completion system 140 may also determine the validity of certain gifts with respect to the itinerary of a traveler. For example, certain airports may include airport lounges, for which a pass may be purchased, and certain other airports may not include the airport lounge. As such, the gifting completion system 140 may analyze the itinerary of a traveler to determine if certain gifts are valid, or should be available for purchase, based on an originating location of travel or destination. In another case, certain airplanes operated by an airline may facilitate some, but not all, gifts. For example, certain airplanes may include WiFi, multimedia services, etc. while other airplanes may not be equipped to offer such services. In these cases, the gifting completion server 140 may analyze modes of travel, assigned vehicles, etc. to determine if certain gifts are valid, or should be available to the customer for purchase.

In yet another implementation, a travel provider may allow the gifting of bundles of gifts for a single price. That is, the gifting completion system 140 may determine the eligibility of gifts individually (WiFi service, first class upgrade, etc.) and in terms of pre-defined or otherwise generated bundles of gifts. Gift bundles may include any combination of travel-related services and products, and, in some cases, the gift bundles may be priced differently than the accumulated prices of the individual gifts within the gift bundles. In this manner, a travel provider may encourage the gifting of multiple ancillary items, as opposed to a single item.

In some cases, travelers may configure a user profile, or otherwise interact with the gifting completion system 140, such that only certain gifting options are available to be gifted to the traveler. For example, a traveler may wish to receive cabin upgrades for air travel but not drink vouchers. As such, the traveler may indicate (e.g., via interactions with web pages generated by the gifting completion system 140) that the gifting completion system 140 should only display preferred gifts (e.g., cabin upgrades) to customers and only allow customers to purchase these preferred gifts. Upon analyzing such traveler-specific, or user-defined, rules, the gifting completion system 140 may determine the specific gifts for the traveler that are available for purchase and that are displayable to customers.

Returning to FIG. 11, information about the customer may also be analyzed to determine gifting recommendations (block 1106). The gifting completion system 140, for example, may analyze names, purchase histories, profiles, locations, etc. of customers to determine particular gifts that may be especially relevant for the customer. In one scenario, the customer may have, under the same name, address, or credit card, purchased drink vouchers for the same or a different traveler in the past. Based on this information about the customer, which may be stored in the database 146, for example, the gifting completion system 140 may prompt the customer with a recommendation to buy drink vouchers or otherwise emphasize (e.g., visually) an option to gift drink vouchers. In another scenario, the traveler, for which the customer is wishing to purchase a gift, may have gifted certain items to the customer in the past. Based on this information, the gifting completion system 140 may suggest that the customer gifts similar items to the traveler so as to “return the favor.” In still another scenario, the gifting completion system 140 may prompt the customer to purchase certain gifts that are temporarily “on sale,” such as gifts that are currently offered at a discounted rate.

In another implementation, the gifting completion system 140 may retrieve and analyze data about the customer from the social network processing system 173, assuming the customer consents to such use of the data. For example, the gifting completion system 140 may analyze data about the customer from the social network processing system 173 to determine: (i) a relationship between the customer and the traveler, such as determining if the customer is a member of the traveler's family, works with the traveler, or is an friend of the traveler, (ii) demographic information about the customer such as location, gender, age, etc., (iii) travel history information about the customer such as recent trip and recently purchases travel-related products, etc. The gifting completion system 140 may utilize such information deduced about the customer to display, emphasize, or promote certain gifts particularly relevant to the customer. For example, if the customer is a member of the traveler's family, the gifting completion system 140 may emphasize higher-priced gifts to the customer, as compared to gifts presented to a friend of the traveler. Generally, the gift completion system 140 may adjust the display, selection, and emphasis of gifts in any suitable many based on information about the customer, where the information is supplied by the customer or is retrieved from the social network processing system 173.

Further, in some implementations, a traveler or customer may configure a user profile, or otherwise interact with the gifting completion system 140, such that travel data, gifting options, etc. are automatically shared with or communicated to only certain types of individuals. For example, a traveler may only wish to share travel data, with gifting options, to family members, and, as such, the traveler may indicate (e.g., via interactions with web pages generated by the gifting completion system 140) that the gifting completion system 140 should automatically notify family members of booked flights, reserved hotels, etc. along with options for gifting travel-related services. Likewise, a traveler may wish to keep travel data secret from certain types of individuals or even specific individuals. In some implementations, the gifting completion system 140 may allow travelers (or customers) to indicate (e.g., via web pages) certain individuals or certain types of individuals with whom travel data should not be shared. For example, a user may enter a name or select certain individuals from a list of social networking connections to indicate that travel data should or should not be shared with those individuals. Alternatively, a traveler may indicate that travel data should not be shared with coworkers and should be shared with family members, for example. Such privacy settings, controlled by the gifting completion system 140, may be controlled at any point, in some examples. That is, the privacy settings may be altered before a trip is booked, after a trip has been booked, before the first gifting of travel related products or services, or after such gifting has begun.

The gifting completion system 140 may also generate recommendations for certain gift bundles, such as the gift bundles discussed further above. Based on previous purchases by the customer, items currently in a “cart,” web pages visited by the customer, etc., the gifting completion system may generate recommendations for the customer to purchase a gift bundle relevant to the previous purchases by the customer, items currently in a “cart,” etc. In one scenario, a customer may add a drink voucher and a first class upgrade to a “cart,” as discussed further with respect to FIG. 7. The gifting completion system 140 may analyze this information and generate a recommendation for the customer for a gift bundles including one or more of the selected items. For example, the gifting completion system 140 may recommend (e.g., via a visual prompt on a web page) that the customer purchase a bundle of a drink voucher, a first class upgrade, and a pass to an airport lounge. The bundle may allow the customer to save money compared to the purchase of each of the gifts individually while promoting the purchase of higher numbers of ancillary products. Generally, such recommendations may be generated at any stage of the purchase, gifting, and sharing of travel-related services/products.

Once specific gifts, gift bundles, and recommendations are generated based on an analysis of a reservation and customer information, indications of the gifts and the recommendations may be presented to the customer (block 1108). For example, the gifting completion system 140 may generate one or more web pages indicating gifts and recommendations, as further discussed with reference to FIGS. 7 and 8.

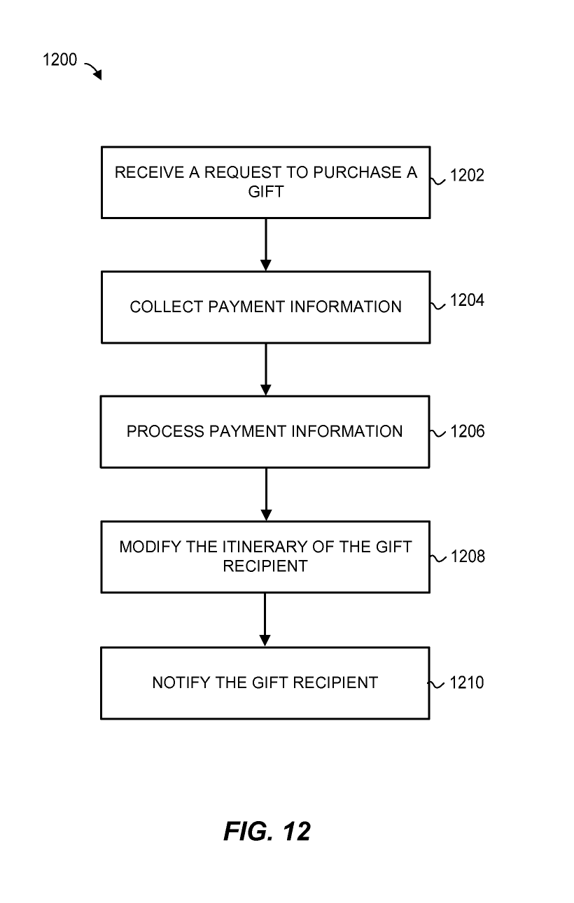

FIG. 12 is a flow diagram of another example method 1200 for gifting travel-related services to a traveler. The gifting completion system 140 may implement the method 1200, for example.

To begin, a request is received to purchase a gift of travel-related services or products (block 1202). For example, a customer may select one or more gifts and/or gift bundles via a series of web pages or application content, as further illustrated with reference to FIGS. 7 and 8. The customer may add the gifts and/or gift bundles to a “cart” or utilize any other suitable method of product selection. The gifting completion system 140 may then collect payment information (block 1204), as further illustrated in the example web page 920 of FIG. 9B, and process the payment information (block 1206). The processing of the payment information may include interactions with any number of systems and servers associated with a travel provider or third party services, such as the credit card processing system 172 and/or the rewards points processing system 175. Generally, a customer may pay for travel-related services and or products with accounts (e.g., credit or debit) from a financial institution, rewards point or frequent flyer miles corresponding to a travel provider, electronic checks, or any other suitable monetary or reward/point-based account.

Once payment for the travel-related products and/or services is processed, the itinerary or reservation of the traveler, for with the products and/or services were purchases, is updated to reflect the purchased products and/or services (block 1208). For example, the gifting completion system 140 may cooperate with the itinerary processing system 174 to add to, update, or otherwise modify reservations or itineraries of travelers. If a gifted product includes an upgrade from an “economy” seat to a first class seat on an airplane, a ticket and itinerary of a traveler may be changed to reflect the change in seating. Such changes may include modifications of entries in a database, deletions of out-of-date travel data corresponding to the traveler, additions of travel data, etc.

The traveler may also be notified of the gifting of travel-related services and/or products by the customer (block 1210). The gifting completion system 140 may generate one or more emails, text messages, mobile alerts (e.g., PUSH alerts), etc. including information about the gifted products and/or services, the customer who purchased the products and/or services, and/or information relevant to utilizing the products and/or services, for example. In some cases, the gifting completion system 140 may also communicate to the traveler updated versions of certain documents, files, etc. For example, the gifting completion system 140 may send, via email, physical mail, and/or otherwise, updated airline tickets based on a upgraded seat on a flight.

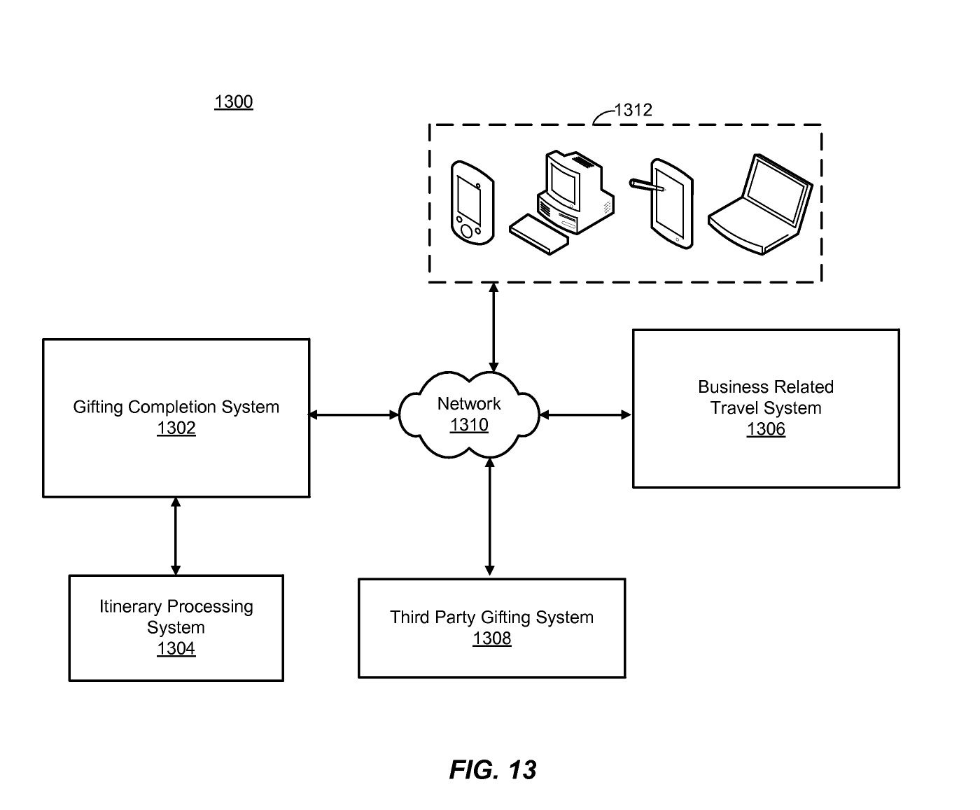

FIG. 13 illustrates various aspects of an example architecture implementing a coordinated gifting system 1300. The coordinated gifting system 1300 may include some components substantially similar to the social gifting system 100. In particular, the coordinated gifting system 1300 may include a gifting completion system 1302 and an itinerary processing system 1304 substantially similar to the gifting completion system 140 and the itinerary processing system 174, which system 1302 may be operated by an airline or other travel provider. The system 1300 also includes a business-related travel system 1306 and a third party gifting system 1308 communicatively connected to the gifting completion system 1302 via a network 1310. The business-related travel system 1306, third party gifting system 1308, and/or the gifting completion system 1302 may be communicatively connected to one or more customer devices 1312 including smartphones, laptop computers, desktop computers, etc.

In an implementation, the business-related travel system 1306 may allow the customer devices 1312, such as devices operated by business employees, to plan, arrange, communicate, etc. travel plans for employees of a business. For example, a travel management partner or agency hired by a business, whose employees operate the devices 1312, may operate the business-related travel system 1306. Customers may interact with the business-related travel system 1306 to book flights, reserve hotels, reserve car service, etc. for business trips, in an implementation, and, in many cases, customers interacting with the business-related travel system 1306 are planning, arranging, or modifying travel plans for a separate individual (e.g., another business employee, client, or coworker).

In another implementation, the business-related travel system 1306 may allow operators of the devices 1312 to track, manage, and utilize business related contacts. The business-related travel system 1306 may implement customer relationship management, contact management, email, electronic document collaboration, etc. functionality to allow business employees and/or clients of a business to easily communicate, interact, or collaboratively work together, for example. By interacting with the business-related travel system 1306, customer may also view certain travel plans, travel notification, reservations, etc. of a coworkers and/or client, in this implementation, assuming the coworkers and/or clients consent to such use of the information.

Generally, the business-related travel system 1306 may include any enterprise or personal software, or software as a service, system which may be utilized by the operators of the devices 1312 to view travel-related information and/or gift travel-related services or products, as discussed below. Although not illustrated in FIG. 13, the business-related travel system 1308 may include components substantially similar to the gifting completion system 140, such as processors, memories, etc.

In one scenario, a customer, operating one of the devices 1312, may plan or arrange a business trip via the business-related travel system 1306. During the process of planning the trip or after the trip is planned, the customer may gift certain travel-related items to a traveler (e.g., a business employee or business client) via the gifting completion system 1302. As described further with reference to FIGS. 1-12, the customer may interact with the gifting completion system 1302 to gift travel-related products or services, and the gifting completion system 1302 may automatically modify traveler itineraries (e.g., via the itinerary processing system 1304) and notify travelers of gifted products and services. However, instead of accessing a gifting interface (as illustrated in FIG. 7) via a social media/networking post or message, the customer may access such an interface via the business-related travel system 1306. That is, within a workflow (e.g., within a portal or series of web pages corresponding to a travel agency) of modifying travel plans for, viewing contact information of, etc. a traveler, a customer may select travel-related gifts to gift to a traveler.

In many cases, such gifting may be completed by the gifting completion system 1302 via a modification of an itinerary, notification of travelers, etc. However, in a some implementations, the gifting completion system 1302 may coordinate gifting of travel-related products and services with the third party gifting system 1308. That is, the gifting completion system 1302 may be operated by a single travel provider (e.g., an airline), but the gifting completion system 1302 may still facilitate the gifting of products and services offered by other commercial entities (e.g., other travel providers or companies, gift card providers, hotels, etc.) via interactions with the third party gifting system 1308. Generally, the third party gifting system 1308 may provide any type of travel-related products and services that may be paired with the products and services offered by the gifting completion system 1302 (or the operator of the system 1302). In one scenario, the gifting completion system may be operated by an airline and the third party gifting system may be operated by a hotel. In such a case, the airline may offer airline related gifts (cabin upgrades, drink vouchers, etc.) and the hotel may offer hotel related gifts (upgraded rooms, resort packages, etc.). However, a customer operating one of the devices 1312 may seamlessly gift products and services offered by both the gifting completion system 1302 and the third party gifting system 1308 via interactions with the business related travel system 1306.

For example, the gifting completion system 1302 may receive a request from the business-related travel system 1306 indicating that a customer wishes to gift an airplane cabin upgrade, offered by an airline that operates the gifting completion system 1302, and a hotel room upgrade, offered by the third party gifting system 1308, to a traveler. The request may include payment information, travel data, traveler information, etc. in an implementation. In response to the request, the gifting completion system 1302 may process the payment for the gifts, modify an itinerary of the traveler via the itinerary processing system 1304, notify the traveler of the gifts, transfer a portion of the payment to an operator of the third party gifting system or a corresponding financial institution, send information about the gifts, customer, and/or traveler to the third party gifting system 1308, etc. In this manner, the gifting completion system 1302 may facilitate coordinated gifting of products and services, where the products and services correspond to multiple travel providers (airlines, hotels, restaurants, etc.) and the gifting completion system 1308 only corresponds to one travel provider.

In some examples, the gifting completion system 1302 receives an automated request from the business-related travel system 1306 for gifting of travel-related services. For example, the system 1306 may include (or coordinate with) a personal information manager system containing meeting and other information for a traveler. If the system 1306, through interactions from the traveler, determines that the traveler may be late for a flight, the system 1306 may send a request to the gifting completion system 1302 for a possible gifting of an expedited priority check screening access at the travel airport for the traveler's flight. In other examples, the business-related travel system 1306, upon making a determination that a travel-itinerary change may be desirable or useful to the travel, communicate a request for gifting of a third party car service, an upgrade to a higher flight class, or other service. The gifting completion system 1302 may be configured, in some examples, to automatically vet these suggested requests, based on rules (such as the nature of the business relationship with the traveler), and then automatically award (or not) the requested travel-related service. While these examples are described in reference to the business-related travel system 1306 making the initial assessment and sending a request, in other examples, the gifting completion system 1302 may probe the system 1306 for identifying information, from which the gifting completion system 1302 determines whether a travel-related service should be automatically gifted. While the systems of FIG. 13 may be implemented in an automated manner, in these such examples, a customer may provide manual control in other examples, where that control may be by the traveler, by the gifting customer, or a combination thereof.

The gifting completion system 1302 may also interact (e.g., communicate) with the business-related travel system 1306 and/or third party gifting system 1308 to emphasize, incentivize, or promote certain travel-related gifts to certain entities. For example, the gifting completion system 1302 may communicate with the business-related travel system 1306 to ensure that certain gifts (such as first class upgrades) are promoted within a gifting interface presented to operators of the devices 1312. In some implementations, the gifting completion system 1302 may incentivize certain gifts on a company-by-company basis such that employees of a certain company are presented with specific gifts while interacting with the business-related travel system 1306. For example, to promote business related gifting or based on subsidized benefits corresponding to certain companies, employees of a first company may receive (while interacting with the business-related travel system 1306) special offers for drink vouchers during air travel while employees of a second company may receive special offers (one day only sales, percentage discounts, buy one get one free, etc.) on cabin upgrades during air travel.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connects the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of the example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but also deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but also deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

This detailed description is to be construed as an example only and does not describe every possible embodiment, as describing every possible embodiment would be impractical, if not impossible. One could implement numerous alternate embodiments, using either current technology or technology developed after the filing date of this application.

What is claimed:

1. A method of gifting travel-related services to a traveler, the method comprising:
receiving, at a gift completion device, trip data from a first user, the trip data including information identifying one or more attributes of a scheduled trip of the first user;
transmitting, by one or more processors, the received trip data from the gift completion device to a network server for displaying the trip data of the first user to a set of secondary users subscribed to access the network server;
transmitting, by the one or more processors, an access link to the network server to allow each of the set of secondary users to access a gifting interface, wherein the gifting interface facilitates the purchase of travel-related services or products corresponding to the trip data;
receiving, from the network server, a first request by at least one of the set of secondary users to access the gifting interface via the access link;
in response to receiving the first request, generating, by the one or more processors, a list of the travel-related services or products for display to the at least one of the set of secondary users; and
in response to receiving a second request from the at least one of the set of secondary users to gift one or more of the travel-related services or products, gifting the one or more of the travel-related services or products to the first user and updating the trip data to include the gifted one or more of the at least some of the travel-related services or products.

2. The method of claim 1, wherein at least some of the travel-related services or products are dependent on the one or more attributes of the scheduled trip of the first user.

3. The method of claim 1, wherein at least some of the travel-related services or products are independent of the one or more attributes of the scheduled trip of the first user.

4. The method of claim 1, wherein at least some of the travel-related services or products are offered for sale by a different commercial entity than other of the travel-related services or products.

5. The method of claim 1, wherein generating the list of the travel-related services or products for display to the at least one of the set of secondary users includes analyzing at least one of information about the set of secondary users or the one or more attributes of the scheduled trip to determine the list of the travel-related services or products.

6. The method of claim 1, wherein generating the list of the travel-related services or products for display to the at least one of the set of secondary users includes analyzing information about the set of secondary users and the one or more attributes of the scheduled trip to determine the list of the travel-related services or products.

7. The method of claim 1, wherein the one or more attributes of the scheduled trip includes flight departure date of a trip, flight departure time of the trip, trip destination, flight departure city of the trip, flight return date of the trip, and/or flight return time of the trip.

8. The method of claim 1, further comprising periodically re-transmitting the received trip data and the access link from the gift completion device to the network server for displaying the trip data of the first user to the set of secondary users.

9. The method of claim 8, further comprising increasing the periodicity of re-transmitting the received trip data and the access link as the scheduled trip approaches in time.

10. The method of claim 1, further comprising, in response to receiving the request from the at least one of the set of secondary users to gift the one or more of the travel-related services or products, notifying the first user about the gifted one or more of the travel-related services or products.

11. The method of claim 1, further comprising, in response to receiving the request from the at least one of the set of secondary users to gift the one or more of the travel-related services or products, transmitting indications of the one or more of the travel-related services or products to the network server for displaying the indications of the one or more of the travel-related services or products gifted on a personalized webpage of at least one of the first user or the at least one of the set of secondary users hosted using the network server.

12. The method of claim 1, wherein transmitting the received trip data and transmitting the access link comprise transmitting the received trip data and the access link to the network server for display on a personalized webpage of the first user hosted using the network server, the personalized webpage being accessible to the set of secondary users through the network server.

13. The method of claim 1, wherein the access link is an Internet-based communication link, and wherein the gifting interface include a plurality of webpages displaying content generated by the gifting completion device.

14. The method of claim 1, further comprising limiting the set of secondary users able to access the gifting interface via the access link based on predetermined connection data indicating a social connection between the first user and each of the set of secondary users.

15. The method of claim 1, further comprising limiting the set of secondary users able to access the gifting interface via the access link to users selected by the first user.

16. The method of claim 1, wherein generating the list of the travel-related services or products for display to the at least one of the set of secondary users comprises:
receiving, from the network server, instructions from the first user identifying which travel-related services or products are displayable to the set of secondary users.

17. The method of claim 1, further comprising:
receiving, from the network server, instructions from the first user identifying which of the gifted one or more travel-related services or products will be displayable on a personalized webpage of at least one of the first user or the at least one of the set of secondary users.

18. The method of claim 1, further comprising receiving payment information for the completing the requested gifting of the one or more of the travel-related services or products.

19. The method of claim 18, wherein the payment information indicates a credit card account, bank transfer, coupon, voucher, gift card account, travel rewards points, or network rewards points.

20. The method of claim 1, further comprising filtering, by the one or more processors, the received trip data based on non-specific rules programmed in the gifting completion device, wherein the non-specific rules are predefined and are utilized to filter a plurality of received trip data from a plurality of users including the first user, and based on specific rules defined via interactions between the first user and the gifting completion device, wherein the specific rules are only utilized to filter the received trip data from the first user.

21. A computing device comprising:
one or more processors; and
a non-transitory computer-readable medium storing instructions thereon that, when executed by the one or more processors, cause the computing device to:
receive trip data from a first user, the trip data including information identifying one or more attributes of a scheduled trip of the first user,
transmit the received trip data from the computing device to a network server for displaying the trip data of the first user to a set of secondary users subscribed to access the network server,
transmit an access link to the network server to allow each of the set of secondary users to access a gifting interface, wherein the gifting interface facilitates the purchase of travel-related services or products corresponding to the trip data,
receive a first request by at least one of the set of secondary users to access the gifting interface via the access link,
in response to receiving the first request, generate a list of the travel-related services or products for display to the at least one of the set of secondary users, and
in response to receiving a second request from the at least one of the set of secondary users to gift one or more of the travel-related services or products, gift the one or more of the travel-related services or products to the first user and updating the trip data to include the gifted one or more of the at least some of the travel-related services or products.

22. The computing device of claim 21, wherein generating the list of the travel-related services or products for display to the at least one of the set of secondary users including generating the list of the travel-related services or products based on at least one of current coupons, current sales, current promotions, or current incentives corresponding to the travel-related services or products.

23. The computing device of claim 21, wherein generating the list of the travel-related services or products for display to the at least one of the set of secondary users including generating the list of the travel-related services or products based on social connections between the at least one of the set of secondary users and the first user.

24. The computing device of claim 21, wherein the received trip data and the access link are automatically transmitted from the computing device to the network server upon receiving the trip data from the first user.

25. The computing device of claim 21, wherein the instructions further cause the computing device to generate the set of secondary users based on one or more options configured by the first user via interactions with the gift completion device.

26. The computing device of claim 25, wherein, based on the one or more options, the instructions cause the computing device to generate the set of secondary users such that the set of secondary users includes one or more individuals who have received gifted travel-related services or products from the traveler in the past.

27. The computing device of claim 25, wherein, based on the one or more options, the instructions cause the computing device to generate the set of secondary users such that the set of secondary users excludes at least one of specific individuals or specific types of individuals.

28. The computing device of claim 25, wherein, based on the one or more options, the instructions cause the computing device to generate the set of secondary users such that the set of secondary users includes at least one of specific individuals or specific types of individuals.
